(19) United States
(12) Patent Application Publication
(10) Pub. No.: US 2026/0335843 A1
(43) Pub. Date: Oct. 29, 2026

(54) Membrane with Increased Hydrophilicity

(71) Applicant: Celanese International Corporation, Irving, TX (US)

(72) Inventors: David Ditter, Sulzbach Am Taunus (DE); Christian Ohm, Sulzbach Am Taunus (DE); Fangfang Tao, Shanghai (CN); Rainer Wakenhorst, Sulzbach Am Taunus (DE); Yingying Sun, Shanghai (CN)

(21) Appl. No.: 19/106,266

(22) PCT Filed: May 30, 2023
(86) PCT No.: PCT/CN2023/097259

§ 371 Date: Feb. 25, 2025

(51) Int. Cl. B01D 71/82; B01D 67/00; B01D 71/26

(52) U.S. Cl. CPC B01D 71/82; B01D 67/00931; B01D 71/261; B01D 2323/36; B01D 2323/38

(57) ABSTRACT

A polymer composition for producing gel extruded articles is described. The polymer composition contains a polyethylene polymer grafted with a surface tension reducing agent optionally combined with unmodified polyethylene particles. In order to form gel extruded articles, the polymer composition is combined with a plasticizer. The polymer articles have dramatically increased wettability properties. The polymer composition is used to form a porous membrane for use as a separator in electronic devices.

### BACKGROUND

Polyethylene polymers have numerous and diverse uses and applications. For example, high density polyethylenes are valuable engineering plastics, with a unique combination of abrasion resistance, surface lubricity, chemical resistance and impact strength. They find application in the production of high strength fibers for use in ropes and anti-ballistic shaped articles and in the production of other elongated articles, such as membranes for electronic devices. However, since the flowability of these materials in the molten state decreases as the molecular weight increases, processing by conventional techniques, such as melt extrusion, is not always possible.

One alternative method for producing fibers and other elongated components from polyethylene polymers is by gel-processing in which the polymer is combined with a solvent. The resultant gel is extruded into a fiber or membrane and may be stretched in one or two directions. After the article is formed, all of the solvent may be removed from the product.

Membranes made from polyethylene polymers through gel-processing can be formed to have many beneficial properties. For instance, the membranes can be formed with micro-pores. Microporous polyethylene membranes formed through gel-processing, for instance, are particularly well suited for use as a separator in a battery, such as a lithium ion battery. The microporous membrane, for instance, can separate an anode from a cathode and prevent a short circuit between the active battery components. At the same time, the microporous membrane permits ions to pass through due to the porous nature of the material. The ion permeability characteristics of the microporous polyethylene membrane makes the material particularly well suited for regulating electrochemical reactions within the battery.

In view of the above, one of the important characteristics of lithium ion battery membranes is the compatibility between the membrane and the electrolyte solution. In this regard, the present disclosure is directed to an improved method for increasing the wettability characteristics of membranes that can be incorporated into lithium ion batteries. The present disclosure is also directed to polymer articles, particularly membranes, which have improved wettability characteristics.

### SUMMARY

In general, the present disclosure is directed to polyolefin compositions well suited for gel-processing applications. More particularly, the present disclosure is directed to a polymer composition containing at least one high density polyethylene polymer well suited for producing microporous, ion permeable membranes that may be used as separators in batteries. In accordance with the present disclosure, the polymer composition is formulated so as to have improved wettability characteristics, particularly with respect to the electrolyte solution found in lithium ion batteries. The improved wettability characteristics increase the mobility of ions contained within the lithium ion battery which increases battery efficiency and lifetime.

In one embodiment, for instance, the present disclosure is directed to a porous membrane made from a high density polyethylene polymer grafted from or to a surface tension reducing agent. In one aspect, the surface tension reducing agent comprises acrylic acid groups. As used herein, acrylic acid groups include acrylic acid, an acrylic acid salt or any group that terminates with an acrylic acid including acrylic acid attached to a spacer group.

In another aspect, the surface tension reducing agent can comprise maleic anhydride groups. In still another aspect, the surface tension reducing agent can comprise a silane. The silane, for instance, can comprise a vinyl silane. In one particular embodiment, the vinyl silane can comprise vinyltrimethoxysilane.

The high density polyethylene polymer grafted to the surface tension reducing agent can be present in the porous membrane in an amount sufficient to reduce a contact angle of the membrane when measured against water. For example, the contact angle of the membrane can be decreased by more than about 4%, such as more than about 5%, such as more than about 6%, such as more than about 7% in comparison to a contact angle of a similar membrane made from the same high density polyethylene polymer but not grafted to the surface tension reducing agent. For example, the contact angle of the porous membrane against water can be less than about 105°, such as less than about 102°, such as less than about 100°, such as less than about 98°.

In addition to having a dramatically reduced contact angle when tested against water, the porous membrane of the present disclosure can also have enhanced wicking properties when tested against electrolyte solutions, such as propylene carbonate. For example, the high density polyethylene polymer grafted to the surface tension reducing agent can be present in the porous membrane sufficient to increase a wicking distance of the membrane when measured according to a soaking test using propylene carbonate. The wicking distance can be increased in an amount of greater than about 10%, such as in an amount greater than about 20%, such as in an amount greater than about 30%, such as in an amount greater than about 35% in comparison to a porous membrane made from the same high density polyethylene polymer that has not been grafted to a surface tension reducing agent.

The surface tension reducing agent can be contained in the porous membrane generally in an amount greater than about 0.001% by weight, such as in an amount greater than about 0.1% by weight, such as in an amount greater than about 0.5% by weight, such as in an amount greater than about 1% by weight, such as in an amount greater than about 2% by weight, such as in an amount greater than about 3% by weight, such as in an amount greater than about 4% by weight, and generally less than about 20% by weight, such less than about 10% by weight, such as less than about 8% by weight. In one embodiment, when the surface tension reducing agent comprises acrylic acid groups, the carbon acid groups of the acrylic acid grafted to the high density polyethylene polymer can be saponified using, for instance, any suitable saponification agent, such as a base. The saponification agent, for instance, can be a sodium hydroxide solution. The saponification agent can contact the grafted polyethylene polymer in resin form or after forming an article, such as a membrane, from the resin.

Optionally, the high density polyethylene polymer grafted to the surface tension reducing agent can be blended with a high density polyethylene polymer that is not grafted to a surface tension reducing agent. The molecular weight of the non-modified high density polyethylene polymer and the molecular weight of the grafted high density polyethylene polymer can be the same or different depending upon the particular application and the desired result. In general, each polymer has a molecular weight of greater than about 500,000 g/mol, such as greater than about 650,000 g/mol, such as greater than about 800,000 g/mol, such as greater than about 1,000,000 g/mol, such as greater than about 2,000,000 g/mol, and generally less than about 12,000,000 g/mol, such as less than about 10,000,000 g/mol. As used herein, the molecular weight is determined according to the Margolies equation.

Porous membranes made according to the present disclosure can be single layer membranes that are free of polypropylene polymers. If desired, the membranes can be optionally coated with an inorganic coating or a polymer coating. In general, the porous membrane can have a thickness of from about 5 microns to about 20 microns. The porous membrane can have a Gurley permeability of generally greater than about 105 sec/100 mL. The porosity of the membrane can be from about 32% to about 50%.

The present disclosure is also directed to a polymer composition for producing gel extruded articles. The polymer composition comprises a plasticizer, optionally non-modified or non-grafted high density polyethylene particles and high density polyethylene particles grafted to a surface tension reducing agent. The surface tension reducing agent, for instance, can comprise acrylic acid groups, maleic anhydride groups, or vinyl silane groups. The vinyl silane groups can comprise vinyltrimethoxysilane.

In one aspect, the surface tension reducing agent comprises the acrylic acid groups. The acrylic acid groups may only include acrylic acid and/or an acrylic acid salt grafted to the high density polyethylene polymer. Alternatively, an acrylic acid monomer including spacer groups (such as styrene groups) can be grafted with the high density polyethylene polymer. The grafted high density polyethylene particles increase the wettability of the polymer composition and of articles made from the composition.

The high density polyethylene particles (grafted and non-grafted) used to produce the membrane can, in one embodiment, have an average particle size (d50) by volume of less than about 150 microns, such as less than about 125 microns, and generally greater than about 50 microns. In one aspect, the grafted high density polyethylene particles can have an average particle size by volume of less than about 200 microns, such as less than about 150 microns, such as less than about 125 microns, and generally greater than about 50 microns.

In general, the polymer composition contains the grafted high density polyethylene resin and optionally the non-grafted high density polyethylene resin in an amount up to about 50% by weight. The plasticizer, for instance, can be present in the composition in an amount greater than about 50% by weight, such as in an amount greater than about 60% by weight, such as in an amount greater than about 70% by weight, such as in an amount greater than about 80% by weight, such as in an amount less than about 90% by weight. Various different materials can be used as the plasticizer. For instance, the plasticizer may comprise a mineral oil, a paraffinic oil, a hydrocarbon oil, an alcohol, or the like. For instance, the plasticizer may comprise decaline, xylene, dioctyl phthalate, dibutyl phthalate, stearyl alcohol, oleyl alcohol, decyl alcohol, nonyl alcohol, diphenyl ether, n-decane, n-dodecane, or mixtures thereof. In one embodiment, the plasticizer may comprise a C5-C12 hydrocarbon, such as a C5-C12 saturated hydrocarbon. For example, the plasticizer may comprise heptane, hexane, a paraffin, or the like.

The present disclosure is also directed to polymer articles formed from the above polymer composition. The polymer articles can be produced through a gel extrusion or gel-spinning process. Polymer articles made in accordance with the present disclosure include fibers, films, such as membranes, or the like.

During the formation of polymer articles, a significant portion of the plasticizer is removed. For example, in one aspect, greater than 95% by weight, such as greater than about 98% by weight of the plasticizer is removed in forming the polymer article. Consequently, polymer articles made in accordance with the present disclosure generally contain the high density polyethylene polymer combined with the grafted high density polyethylene polymer in an amount of from about 60% to about 99.5% by weight, such as in an amount from about 65% by weight to about 97% by weight.

The present disclosure is also directed to a process for producing polymer articles. The process includes the steps of forming a gel-like composition from the polymer composition described above. The gel-like composition is then extruded through a die to form a polymer article. The polymer article, for instance, may comprise a porous membrane.

In one embodiment, an extraction solvent, such as dichloromethane is combined with the polymer composition before or during formation of the polymer article. The extraction solvent can be used to facilitate removal of the plasticizer.

Porous membranes made in accordance with the present disclosure can have an excellent blend of physical properties. The porous membranes, for instance, can have excellent tensile strength and can be puncture resistant.

Other features and aspects of the present disclosure are discussed in greater detail below.

### BRIEF DESCRIPTION OF THE DRAWINGS

The present disclosure may be better understood with reference to the following FIGURE:

FIG. 1 is a cross-sectional view of an electronic device, such as a battery, incorporating a porous membrane made in accordance with the present disclosure;

Repeat use of reference characters in the present specification and drawings is intended to represent the same or analogous features or elements of the present invention.

### DEFINITIONS

The melt flow rate of a polymer or polymer composition is measured according to ISO Test 1133 at 190 °C and at a load of 21.6 kg.

The density of a polymer is measured according to ISO Test 1183 in units of g/cm³.

Average particle size (d50) is measured using laser diffraction/light scattering, such as a suitable Horiba light scattering device.

The average molecular weight of a polymer is determined using the Margolies' equation.

Tensile modulus, tensile stress at yield, tensile strain at yield, tensile stress at 50% break, tensile stress at break, and tensile nominal strain at break are all measured according to ISO Test 527-2/1 B.

Contact angle measurements are performed on a Kruss DSA 100 instrument. A membrane sample (10×40 mm) is attached to a microscope slide using double sided adhesive tape. Static charging is dissipated by moving the prepared sample several times through a U-electrode static discharger. The sample is mounted in a measurement device and a 3.5 μl droplet of testing fluid (water or ethylene glycol) is placed on the membrane. The contact angle is determined through the software for 7 seconds (one measurement per second) after placement of the droplet. These 7 data points are averaged to yield the contact angle at the point of measurement. Every sample is measured at 6 different spots or locations on each side and all results are averaged to the reported value.

A soaking test may be used to determine the wicking characteristics of membranes made in accordance with the present disclosure according to the following procedure.

For the soaking test a glass vessel is used with following dimensions: 20×10 cm upper area (covered with a metal plate)/19×8 cm lower area (base)/height: 10 cm). Two filter papers are sticked at the inside of the glass vessel with a tape. 300 ml propylene carbonate is filled into the vessel afterwards (fluid level: 2 cm). The vessel is covered with a metal plate and propylene carbonate is allowed to fill the gas space for 20 minutes.

Membranes are cut with scissors into pieces (length: 70 mm, width: 7 mm). This is done with nitrile gloves to prevent touching the membranes with the bare hand. The pieces are mounted on an anodized metal plate (140 mm×70 mm, frame width: 10 mm, slope: 80°) with the help of magnets. The MD direction of membranes shows upwards (=soaking direction).

The metal frame with the fixed membranes are then moved 40 times through a deionizer to remove electrostatic charges. After that the frame is placed into the vessel filled with propylene carbonate at room temperature and soaking of the membranes with propylene carbonates takes place for a desired time. During soaking takes place the vessel is closed with a metal plate. The different soaking distances of the membranes are measured every 30 minutes by taking a photo and measuring the distance with a suitable computer program.

Soaking distances of tested membranes is compared to draw conclusion on their battery electrolyte affinity.

Gurley permeability can be measured according to the Gurley Test, using a Gurley permeability tester, such as Gurley Densometer, Model KRK 2060c commercially available from Kumagai Riki Kogyo Co., LTD. The test is conducted according to ISO Test 5636. The Gurley Test measures air permeability as a function of the time required for a specified amount of air to pass through a specified area under a specified pressure. The units are reported in sec/100 ml.

Porosity (%) is measured according to the following procedure. During the procedure, the following ASTM Standards are used as a reference: D622 Standard Test Method for Apparent Density of Rigid Cellular Plastics1; and D729 Standard Test Methods for Density and Specific Gravity (Relative Density) of Plastics by Displacement1. The following instruments are used: Calibrated Analytical Balance (0.0001 grams); Lorentzen & Wettre Micrometer, code 251 (0.1 um); and Deli 2056 art knife.

### Procedure:

1.1. Samples and sample preparation
Using the specimen art knife, cut each sample material into a minimum of three 60 mm±0.5 by 60 mm±0.5 specimens
1.2. Instrument and measurement
3.2.1 Using the L&W micrometer, take five readings of the thickness at each 60 mm by 60 mm specimen (average of 5 readings). Record this value as the thickness of this specimen.
3.2.2 Weigh the specimen directly on the balance. Record this value as the weight of this specimen.
3.2.3 The three specimens of the same sample are placed together and steps
3.2.1 and 3.2.2 are repeated to obtain the [bulk]thickness and the [bulk] weight.
Calculate the density to three significant figures as follows
a. Dfilm=Density (film)=Wt. of Specimen
THK*Square
Dfilm=density of specimen, (mg/mm3)
Wt=weight of specimen, (mg)
THK=thickness of specimen, (mm)
Square=area of specimen, (mm2)
b. Dpolymer=Density (polymer) 0.95 (g/cm3)
Dpolymer: Density of raw materials, without the pores.
c. Porosity=(1−Dfilm/Dpolymer)*100%

As used herein, puncture strength is measured according to ASTM Test D3763 and measures the ability of a membrane to withstand a foreign particle from causing a hole or defect. The test is conducted on a testing device, such as an Instron CEAST 9340 device. The drop height is 0.03 to 1.10 m. The impact velocity is 0.77 to 4.65 m/s. The maximum dropping mass is 37.5 kg and the maximum potential energy is 405 J. Puncture strength is measured in slow speed puncture mode at 1.67 mm/s. Puncture strength can be normalized by dividing by the thickness of the membrane resulting in units of mN/micron.

Heat shrinkage of a membrane is determined by putting a piece of membrane (3 in×3 in) in an oven at 105 °C for 1 h. Shrinkage is calculated by measuring the size in MD and TD direction before and after heat treatment.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a polymer composition well suited for producing gel extruded articles, such as fibers and films, including porous membranes. The polymer composition contains a high density polyethylene polymer that has been grafted with a surface tension reducing agent, optionally high density polyethylene particles (unmodified or nongrafted), and a plasticizer. The surface tension reducing agent, for instance, can be acrylic acid groups, maleic anhydride groups, or vinyl silane groups. The high density polyethylene polymer grafted to the surface tension reducing agent can dramatically reduce surface tension and increase the wettability characteristics of polymer articles formed from the polymer composition when tested against liquids, such as water. In addition to improving the wettability characteristics, polymer articles made according to the present disclosure can also display dramatically enhanced wicking properties.

Incorporating a high density polyethylene polymer grafted to a surface tension reducing agent into a membrane made in accordance with the present disclosure can provide various advantages and benefits, especially when the membrane is used as an ion separator in a lithium ion battery. For example, improved wettability helps reduce the battery membrane soaking time, which leads to higher productivity. In addition, the increased wettability with the electrolyte solution increases the mobility of the ions, such as the lithium ions, which can significantly increase battery lifetime. Further, membranes made according to the present disclosure can have improved wicking properties when contacted with an electrolyte solution.

Polymer articles made according to the present disclosure can be made exclusively from a single polyolefin polymer comprising the high density polyethylene polymer grafted to the surface tension reducing agent. Alternatively, the polymer articles can be formed from a polymer blend. The polymer blend can comprise a blend of polyethylene polymers that each have been grafted to different surface tension reducing agents. In still another embodiment, polymer articles can be formed from a high density polyethylene polymer grafted to a surface tension reducing agent blended with a non-modified or non-grafted high density polyethylene polymer that has not been grafted to a surface tension reducing agent. For example, in one embodiment, a portion of a first polyethylene polymer can be grafted with the surface tension reducing agent in order to produce a second grafted polyethylene polymer. Alternatively, the first polyethylene polymer and the second polyethylene polymer that is reacted with the surface tension reducing agent can have different characteristics, such as different molecular weights, densities, bulk densities, or the like.

The high density polyethylene polymers (grafted and non-grafted) for use in the present disclosure can have a density of about 0.93 g/cm³ or greater, such as about 0.94 g/cm³ or greater, such as about 0.95 g/cm³ or greater, and generally less than about 1 g/cm³, such as less than about 0.96 g/cm³.

The high density polyethylene polymers can be made from over 90% ethylene derived units, such as greater than 95% ethylene derived units, or from 100% ethylene derived units. The polyethylene can be a homopolymer or a copolymer, including a terpolymer, having other monomeric units.

The high density polyethylene can be a high molecular weight polyethylene, a very high molecular weight polyethylene, and/or an ultrahigh molecular weight polyethylene. “High molecular weight polyethylene” refers to polyethylene compositions with an average molecular weight of at least about 3×10⁵ g/mol and, as used herein, is intended to include very-high molecular weight polyethylene and ultra-high molecular weight polyethylene. For purposes of the present specification, the molecular weights referenced herein are determined in accordance with the Margolies equation (“Margolies molecular weight”).

“Very-high molecular weight polyethylene” refers to polyethylene compositions with a weight average molecular weight of less than about 3×10⁶ g/mol and more than about 1×10⁶ g/mol. In some embodiments, the molecular weight of the very-high molecular weight polyethylene composition is between about 2×10⁶ g/mol and less than about 3×10⁶ g/mol.

“Ultra-high molecular weight polyethylene” refers to polyethylene compositions with an average molecular weight of at least about 3×10⁶ g/mol. In some embodiments, the molecular weight of the ultra-high molecular weight polyethylene composition is between about 3×10⁶ g/mol and about 30×10⁶ g/mol, or between about 3×10⁶ g/mol and about 20×10⁶ g/mol, or between about 3×10⁶ g/mol and about 10×10⁶ g/mol, or between about 3×10⁶ g/mol and about 6×10⁶ g/mol.

In one aspect, the high density polyethylene is a homopolymer of ethylene. In another embodiment, the high density polyethylene may be a copolymer. For instance, the high density polyethylene may be a copolymer of ethylene and another olefin containing from 3 to 16 carbon atoms, such as from 3 to 10 carbon atoms, such as from 3 to 8 carbon atoms. These other olefins include, but are not limited to, propylene, 1-butene, 1-pentene, 1-hexene, 1-heptene, 1-octene, 4-methylpent-1-ene, 1-decene, 1-dodecene, 1-hexadecene and the like. Also utilizable herein are polyene comonomers such as 1, 3-hexadiene, 1, 4-hexadiene, cyclopentadiene, dicyclopentadiene, 4-vinylcyclohex-1-ene, 1, 5-cyclooctadiene, 5-vinylidene-2-norbornene and 5-vinyl-2-norbornene. However, when present, the amount of the non-ethylene monomer (s) in the copolymer may be less than about 10 mol. %, such as less than about 5 mol. %, such as less than about 2.5 mol. %, such as less than about 1 mol. %, wherein the mol. % is based on the total moles of monomer in the polymer.

In one embodiment, the high density polyethylene may have a monomodal molecular weight distribution. Alternatively, the high density polyethylene may exhibit a bimodal molecular weight distribution. For instance, a bimodal distribution generally refers to a polymer having a distinct higher molecular weight and a distinct lower molecular weight (e.g. two distinct peaks) on a size exclusion chromatography or gel permeation chromatography curve. In another embodiment, the high density polyethylene may exhibit more than two molecular weight distribution peaks such that the polyethylene exhibits a multimodal (e.g., trimodal, tetramodal, etc.) distribution. Alternatively, the high density polyethylene may exhibit a broad molecular weight distribution wherein the polyethylene is comprised of a blend of higher and lower molecular weight components such that the size exclusion chromatography or gel permeation chromatography curve does not exhibit at least two distinct peaks but instead exhibits one distinct peak broader than the individual component peaks.

Any method known in the art can be utilized to synthesize the polyethylene. The polyethylene powder is typically produced by the catalytic polymerization of ethylene monomer or optionally with one or more other 1-olefin co-monomers, the 1-olefin content in the final polymer being less or equal to 10% of the ethylene content, with a heterogeneous catalyst and an organo aluminum or magnesium compound as cocatalyst. The ethylene is usually polymerized in gaseous phase or slurry phase at relatively low temperatures and pressures. The polymerization reaction may be carried out at a temperature of between 50 °C and 100 °C and pressures in the range of 0.02 and 2 MPa.

The molecular weight of the polyethylene can be adjusted by adding hydrogen. Altering the temperature and/or the type and concentration of the co-catalyst may also be used to fine tune the molecular weight. Additionally, the reaction may occur in the presence of antistatic agents to avoid fouling and product contamination.

Suitable catalyst systems include but are not limited to Ziegler-Natta type catalysts. Typically, Ziegler-Natta type catalysts are derived by a combination of transition metal compounds of Groups 4 to 8 of the Periodic Table and alkyl or hydride derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum or magnesium compounds, such as for example but not limited to aluminum or magnesium alkyls and titanium, vanadium or chromium halides or esters. The heterogeneous catalyst might be either unsupported or supported on porous fine grained materials, such as silica or magnesium chloride. Such support can be added during synthesis of the catalyst or may be obtained as a chemical reaction product of the catalyst synthesis itself.

In one embodiment, a suitable catalyst system can be obtained by the reaction of a titanium (IV) compound with a trialkyl aluminum compound in an inert organic solvent at temperatures in the range of −40 °C to 100 °C, preferably −20 °C to 50 °C. The concentrations of the starting materials are in the range of 0.1 to 9 mol/L, preferably 0.2 to 5 mol/L, for the titanium (IV) compound and in the range of 0.01 to 1 mol/L, preferably 0.02 to 0.2 mol/L for the trialkyl aluminum compound. The titanium component is added to the aluminum component over a period of 0.1 min to 60 min, preferably 1 min to 30 min, the molar ratio of titanium and aluminum in the final mixture being in the range of 1:0.01 to 1:4.

In another embodiment, a suitable catalyst system is obtained by a one or two-step reaction of a titanium (IV) compound with a trialkyl aluminum compound in an inert organic solvent at temperatures in the range of −40 °C to 200 °C, preferably −20 °C to 150 °C. In the first step the titanium (IV) compound is reacted with the trialkyl aluminum compound at temperatures in the range of −40 °C to 100 °C, preferably −20 °C to 50 °C using a molar ratio of titanium to aluminum in the range of 1:0.1 to 1:0.8. The concentrations of the starting materials are in the range of 0.1 to 9.1 mol/L, preferably 5 to 9.1 mol/L, for the titanium (IV) compound and in the range of 0.05 and 1 mol/L, preferably 0.1 to 0.9 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10 °C to 150 °C, preferably 10 °C to 130 °C using a molar ratio of titanium to aluminum in the range of 1:0.01 to 1:5.

In yet another embodiment, a suitable catalyst system is obtained by a procedure wherein, in a first reaction stage, a magnesium alcoholate is reacted with a titanium chloride in an inert hydrocarbon at a temperature of 50° to 100 °C. In a second reaction stage the reaction mixture formed is subjected to heat treatment for a period of about 10 to 100 hours at a temperature of 110° to 200 °C accompanied by evolution of alkyl chloride until no further alkyl chloride is evolved, and the solid is then freed from soluble reaction products by washing several times with a hydrocarbon.

In a further embodiment, catalysts supported on silica, such as for example the commercially available catalyst system Sylopol 5917 can also be used.

Using such catalyst systems, the polymerization is normally carried out in suspension at low pressure and temperature in one or multiple steps, continuous or batch. The polymerization temperature is typically in the range of 30 °C to 130 °C, preferably is the range of 50 °C and 90 °C and the ethylene partial pressure is typically less than 10 MPa, preferably 0.05 and 5 MPa. Trialkyl aluminums, like for example but not limited to isoprenyl aluminum and triisobutyl aluminum, are used as co-catalyst such that the ratio of Al:Ti (co-catalyst versus catalyst) is in the range of 0.01 to 100:1, more preferably is the range of 0.03 to 50:1. The solvent is an inert organic solvent as typically used for Ziegler type polymerizations. Examples are butane, pentane, hexane, cyclohexene, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried in a fluidized bed drier under nitrogen. The solvent may be removed through steam distillation in case of using high boiling solvents. Salts of long chain fatty acids may be added as a stabilizer. Typical examples are calcium, magnesium and zinc stearate.

Optionally, other catalysts such as Phillips catalysts, metallocenes and post metallocenes may be employed. Generally, a cocatalyst such as alumoxane or alkyl aluminum or alkyl magnesium compound is also employed. Other suitable catalyst systems include Group 4 metal complexes of phenolate ether ligands.

In one embodiment, the polyethylene particles are made from a polyethylene polymer having a relatively low bulk density as measured according to DIN53466. For instance, in one embodiment, the bulk density is generally less than about 0.4 g/cm³, such as less than about 0.35 g/cm³, such as less than about 0.33 g/cm³, such as less than about 0.3 g/cm³, such as less than about 0.28 g/cm³, such as less than about 0.26 g/cm³. The bulk density is generally greater than about 0.1 g/cm³, such as greater than about 0.15 g/cm³. In one embodiment, the polymer has a bulk density of from about 0.2 g/cm³ to about 0.27 g/cm³.

In one embodiment, the polyethylene particles (grafted or non-grafted) can be a free-flowing powder. The particles can have an average particle size (d50) by volume of less than 200 microns. For example, the average particle size (d50) of the polyethylene particles can be less than about 150 microns, such as less than about 125 microns. The average particle size (d50) is generally greater than about 20 microns. The powder particle size can be measured utilizing a laser diffraction method according to ISO 13320.

In one embodiment, 90% of the polyethylene particles can have a particle size of less than about 250 microns. In other embodiments, 90% of the polyethylene particles can have a particle size of less than about 200 microns, such as less than about 170 microns.

The molecular weight of the polyethylene polymer can vary depending upon the particular application. The polyethylene polymer, for instance, may have an average molecular weight, as determined according to the Margolies equation. The molecular weight can be determined by first measuring the viscosity number according to DIN EN ISO Test 1628. Dry powder flow is measured using a 25 mm nozzle. The molecular weight is then calculated using the Margolies equation from the viscosity numbers. The average molecular weight is generally greater than about 300,000 g/mol, such as greater than about 500,000 g/mol, such as greater than about 650,000 g/mol, such as greater than about 1,000,000 g/mol, such as greater than about 2,000,000 g/mol, such as greater than about 2,500,000 g/mol, such as greater than about 3,000,000 g/mol, such as greater than about 4,000,000 g/mol. The average molecular weight is generally less than about 12,000,000 g/mol, such as less than about 10,000,000 g/mol. In one aspect, the number average molecular weight of the high density polyethylene polymer can be less than about 4,000,000 g/mol, such as less than about 3,000,000 g/mol.

The polyethylene may have a viscosity number of from at least 100 mL/g, such as at least 500 mL/g, such as at least 550 mL/g, to less than about 6,000 mL/g, such as less than about 5,000 mL/g, such as less than about 4000 mL/g, such as less than about 3,000 mL/g, such as less than about 1,000 mL/g, as determined according to ISO 1628 part 3 utilizing a concentration in decahydronapthalene of 0.0002 g/mL.

The high density polyethylene may have a crystallinity of from at least about 40% to 85%, such as from 45% to 80%. In one aspect, the crystallinity can be greater than about 50%, such as greater than about 55%, such as greater than about 60%, such as greater than about 65%, such as greater than about 70%, and generally less than about 80%.

As described above, the polymer composition of the present disclosure contains a polyethylene polymer that has been grafted to a surface tension reducing agent. The polymer composition can contain a single polymer comprising the grafted high density polyethylene polymer. In other embodiments, however, the polymer composition can contain a blend of polyethylene polymers in which the polyethylene polymers are grafted to different surface tension reducing agents. In still another embodiment, a polyethylene polymer grafted to a surface tension reducing agent is blended with a non-grafted high density polyethylene polymer. Each polyethylene polymer can be in the form of particles. Each particle can contain a single polyethylene polymer or particles can be formed containing a blend of polymers. The particles are then fed through a gel extrusion process for producing polymer articles.

In accordance with the present disclosure, the surface tension reducing agent grafted to the high density polyethylene polymer can vary depending upon the particular application. The surface tension reducing agent, for instance, can comprise acrylic groups, maleic anhydride groups, or silane groups.

As described above, in one aspect, the surface tension reducing agent grafted to the polyethylene polymer can be an acrylic acid. The acrylic acid groups can include acrylic acid, an acrylic acid salt or any group that terminates with an acrylic acid including acrylic acid groups attached to a spacer group. The amount of acrylic acid grafted to the polyethylene polymer can generally be greater than about 0.5% by weight, such as in an amount greater than about 1% by weight, such as in an amount greater than about 2% by weight, such as in an amount greater than about 3% by weight, such as in an amount greater than about 4% by weight. The amount of acrylic acid grafted to the polyethylene polymer is generally less than about 25% by weight, such as less than about 15% by weight, such as less than about 12% by weight, such as less than about 10% by weight, such as less than about 8% by weight.

In one embodiment, once the acrylic acid is grafted to the polyethylene polymer, the acrylic acid can be saponified. Saponification can occur on the polymer resin or polymer particles or can occur after an article has been formed. In one aspect, the acrylic acid groups can be saponified by contacting the acrylic acid groups with a saponification agent. Any suitable saponification agent, such as a base, can be used. The saponification agent, for instance, can be a basic solution, such as a sodium hydroxide solution.

Optionally, the acrylic acid groups can be contacted with an inorganic salt solution, such as a metal salt solution. The metal salt can be an alkaline earth metal halide salt. In one embodiment, for instance, the inorganic salt can be a calcium salt, such as calcium chloride. The polymer, for instance, can be submerged in a calcium chloride solution at a temperature of about 23 °C or higher, such as from about 23 °C to about 60 °C, such as from about 30 °C to about 50 °C. The calcium chloride solution can have any suitable concentration. For instance, the calcium chloride solution can be a 0.5 to 3 molar calcium chloride solution. Optionally, a base can be present in the solution, such as sodium hydroxide. The inorganic salt solution may cause cross-links to form.

After saponification, the polymer resin or article can be dried. In one embodiment, as described above, the acrylic acid groups may cause some crosslinking to occur with the polyethylene polymer. In an alternative embodiment, however, the grafted polyethylene polymer may not be crosslinked. The improved properties of the present disclosure are realized without a crosslinking reaction occurring. Thus, if crosslinking were to occur, in one aspect, less than about 70%, such as less than about 50%, such as less than about 30% of the acrylic acid groups may undergo crosslinking.

In an alternative embodiment, the surface tension reducing agent can comprise a maleic anhydride. The maleic anhydride can be grafted to the high density polyethylene polymer in the same amounts as described above. For instance, the maleic anhydride grafted high density polyethylene polymer can contain maleic anhydride groups in an amount greater than about 0.5% by weight, such as in an amount greater than about 1% by weight, such as in an amount greater than about 2% by weight, such as in an amount greater than about 3% by weight, such as in an amount greater than about 4% by weight, and in an amount less than about 25% by weight, such as in an amount less than about 15% by weight, such as in an amount less than about 12% by weight, such as in an amount less than about 10% by weight, such as in an amount less than about 8% by weight.

In still another embodiment, the surface tension reducing agent can comprise silane groups. For instance, the silane can be a vinyl silane. In one aspect, the surface tension reducing agent can be a vinyl silane containing alkoxy groups. For example, the silane can be vinyltrimethoxysilane, vinyltriethoxysilane, vinyltriacetoxysilane, or mixtures thereof. The vinyl silane groups can be grafted to the high density polyethylene polymer in an amount greater than about 0.5% by weight, such as in an amount greater than about 1% by weight, such as in an amount greater than about 2% by weight, such as in an amount greater than about 3% by weight, such as in an amount greater than about 4% by weight, and in an amount less than about 25% by weight, such as in an amount less than about 15% by weight, such as in an amount less than about 12% by weight, such as in an amount less than about 10% by weight, such as in an amount less than about 8% by weight.

The average molecular weight of the polyethylene polymer that is grafted to the surface tension reducing agent can generally be greater than about 300,000 g/mol, such as greater than about 500,000 g/mol, such as greater than about 650,000 g/mol, such as greater than about 800,000 g/mol, such as greater than about 1,000,000 g/mol. The molecular weight of the polyethylene polymer grafted to the surface tension reducing agent is generally less than about 10,000,000 g/mol, such as less than about 2,000,000 g/mol, such as less than about 1,000,000 g/mol.

When combined with an unmodified or ungrafted high density polyethylene polymer, the polymer composition (or polymer article made from the composition) can be formulated such that the surface tension reducing agent grafted polyethylene polymer is present in the composition in an amount greater than about 0.5% by weight, such as in an amount greater than about 1% by weight, such as in an amount greater than about 2% by weight, such as in an amount greater than about 5% by weight, such as in an amount greater than about 7% by weight, such as in an amount greater than about 10% by weight, such as in an amount greater than about 12% by weight, such as in an amount greater than about 15% by weight, such as in an amount greater than about 18% by weight, such as in an amount greater than about 20% by weight, such as in an amount greater than about 30% by weight, such as in an amount greater than about 40% by weight, such as in an amount greater than about 50% by weight, such as in an amount greater than about 60% by weight, such as in an amount greater than about 70% by weight, such as in an amount greater than about 80% by weight (based upon the total amount of polymer present and excluding plasticizer). In general, the polymer composition can contain the grafted polyethylene polymer in an amount less than about 90% by weight, such as in an amount less than about 70% by weight, such as in an amount less than about 50% by weight, such as in an amount less than about 30% by weight, such as in an amount less than about 20% by weight, such as in an amount less than about 10% by weight, when combined with an unmodified polyethylene polymer.

The amount of the surface tension reducing agent contained in the polymer composition can vary depending upon the amount of surface tension reducing agent grafted to the polyethylene polymer and the amount of the grafted polyethylene polymer present in the composition. In general, the amount of the surface tension reducing agent contained in the polymer composition (or articles made from the composition) based on the total amount of polymers present (and excluding plasticizers) is generally greater than about 0.001% by weight, such as in an amount greater than about 0.01% by weight, such as in an amount greater than about 0.05% by weight, such as in an amount greater than about 0.1% by weight, such as in an amount greater than about 0.3% by weight, such as in an amount greater than about 0.5% by weight, such as in an amount greater than about 1% by weight, such as in an amount greater than about 2% by weight, such as in an amount greater than about 3% by weight, such as in an amount greater than about 4% by weight, such as in an amount greater than about 5% by weight, such as in an amount greater than about 8% by weight. The amount of the surface tension reducing agent contained in the polymer composition and in articles made from the composition can be less than about 20% by weight, such as less than about 10% by weight, such as less than about 8% by weight, such as less than about 5% by weight, such as less than about 4% by weight, such as less than about 3% by weight, such as less than about 2% by weight, such as less than about 1% by weight, such as less than about 0.8% by weight, such as in an amount less than about 0.5% by weight.

The grafted polyethylene polymer can be in the form of particles that are optionally blended with unmodified high density polyethylene polymer particles. When combined with an unmodified or non-grafted high density polyethylene polymer, the non-grafted high density polyethylene polymer can have the same molecular weight, a lower molecular weight, or a higher molecular weight than the high density polyethylene polymer grafted with the surface tension reducing agent. The particles can have an average particle size (d50) by volume of less than about 400 microns, such as less than about 300 microns, such as less than about 200 microns, such as less than about 170 microns, such as less than about 150 microns, such as less than about 125 microns. The average particle size can be greater than about 20 microns, such as greater than about 30 microns, such as greater than about 40 microns, such as greater than about 50 microns.

The grafted polyethylene polymer can be combined with one or more non-grafted polyethylene polymers to produce molded articles. For instance, different high density polyethylene polymers can be combined with the grafted polyethylene polymer that have at least one characteristic, such as molecular weight, which is different than the other non-grafted polyethylene polymers present. For instance, in one embodiment, the polymer composition can contain two or three different high density polyethylene particles that are then combined with the grafted polyethylene polymer. In still another embodiment, polymer articles can be made exclusively from the grafted polyethylene polymer.

In order to form molded articles in accordance with the present disclosure, the polymer composition containing the grafted polyethylene polymer is combined with a plasticizer according to a process known as gel processing. During gel processing, one or more plasticizers is combined with the polymer composition which can then be later removed in forming polymer articles.

The polymer composition fed through the gel extrusion process can contain one or more high density polyethylene particles in combination with one or more plasticizers and various other additives and ingredients. The composition fed through the gel extrusion process can contain the high density polyethylene polymer grafted to the surface tension reducing agent and optionally other polyethylene polymers in an amount of from about 1% by weight to about 50% by weight. For instance, the high density polyethylene particles can be present in the polymer composition in an amount less than about 45% by weight, such as in an amount less than about 40% by weight, such as in an amount less than about 35% by weight, such as in an amount less than about 30% by weight, such as in an amount less than about 25% by weight, such as in an amount less than about 20% by weight, such as in an amount less than about 15% by weight. The polyethylene particles can be present in the composition in an amount greater than about 5% by weight, such as in an amount greater than about 10% by weight, such as in an amount greater than about 15% by weight, such as in an amount greater than about 20% by weight, such as in an amount greater than about 25% by weight.

After gel processing, one or more plasticizers are typically removed from the polymer composition in forming the polymer articles. Consequently, the resulting polymer article can contain one or more high density polyethylene polymers in an amount greater than about 50% by weight, such as in an amount greater than about 60% by weight, such as in an amount greater than about 70% by weight, such as in an amount greater than about 80% by weight, such as in an amount greater than about 90% by weight, such as in an amount greater than about 95% by weight, such as in an amount greater than about 97% by weight.

In general, any suitable plasticizer can be combined with the other components as long as the plasticizer is capable of forming a gel-like material suitable for gel spinning or extruding. The plasticizer, for instance, may comprise a hydrocarbon oil, an alcohol, an ether, an ester such as a diester, or mixtures thereof. For instance, suitable plasticizers include mineral oil, a paraffinic oil, decaline, and the like. Other plasticizers include xylene, dioctyl phthalate, dibutyl phthalate, stearyl alcohol, oleyl alcohol, decyl alcohol, nonyl alcohol, diphenyl ether, n-decane, n-dodecane, octane, nonane, kerosene, toluene, naphthalene, tetraline, and the like. In one embodiment, the plasticizer may comprise a halogenated hydrocarbon, such as monochlorobenzene. Cycloalkanes and cycloalkenes may also be used, such as camphene, methane, dipentene, methylcyclopentandiene, tricyclodecane, 1, 2, 4, 5-tetramethyl-1, 4-cyclohexadiene, and the like. The plasticizer may comprise mixtures and combinations of any of the above as well.

The plasticizer is generally present in the composition used to form the polymer articles in an amount greater than about 50% by weight, such as in an amount greater than about 55% by weight, such as in an amount greater than about 60% by weight, such as in an amount greater than about 65% by weight, such as in an amount greater than about 70% by weight, such as in an amount greater than about 75% by weight, such as in an amount greater than about 80% by weight, such as in an amount greater than about 85% by weight, such as in an amount greater than about 90% by weight, such as in an amount greater than about 95% by weight, such as in an amount greater than about 98% by weight. In fact, the plasticizer can be present in an amount up to about 99.5% by weight.

In order to form polymer articles in accordance with the present disclosure, the high density polyethylene particles and grafted polyethylene polymer particles are combined with the plasticizer and extruded through a die of a desired shape. In one embodiment, the composition can be heated within the extruder. For example, the plasticizer can be combined with the particle mixture and fed into an extruder. In accordance with the present disclosure, the plasticizer and particle mixture form a homogeneous gel-like material prior to leaving the extruder for forming polymer articles with little to no impurities.

In one embodiment, elongated articles are formed during the gel spinning or extruding process. The polymer article, for instance, may be in the form of a fiber or a film, such as a membrane.

During the process, at least a portion of the plasticizer is removed from the final product. The plasticizer removal process may occur due to evaporation when a relatively volatile plasticizer is used. Otherwise, an extraction liquid can be used to remove the plasticizer. The extraction liquid may comprise, for instance, a hydrocarbon solvent. One example of the extraction liquid, for instance, is dichloromethane. Other extraction liquids include acetone, chloroform, an alkane, hexene, heptene, an alcohol, or mixtures thereof.

If desired, the resulting polymer article can be stretched at an elevated temperature below the melting point of the polymer mixture to increase strength and modulus. Suitable temperatures for stretching are in the range of from about ambient temperature to about 155 °C. The draw ratios can generally be greater than about 4, such as greater than about 6, such as greater than about 8, such as greater than about 10, such as greater than about 15, such as greater than about 20, such as greater than about 25, such as greater than about 30. In certain embodiments, the draw ratio can be greater than about 50, such as greater than about 100, such as greater than about 110, such as greater than about 120, such as greater than about 130, such as greater than about 140, such as greater than about 150. Draw ratios are generally less than about 1,000, such as less than about 800, such as less than about 600, such as less than about 400. In one embodiment, lower draw ratios are used such as from about 4 to about 10. The polymer article can be uniaxially stretched or biaxially stretched.

As described above, in one embodiment, after stretching, the polymer articles may be subjected to a saponification process when the surface tension reducing agent comprises acrylic acid groups. Saponification can occur by contact with a basic solution, such as a sodium hydroxide solution.

Polymer articles made in accordance with the present disclosure have numerous uses and applications. For example, in one embodiment, the process is used to produce a porous membrane. The membrane can be used, for instance, as a battery separator. Alternatively, the membrane can be used as a microfilter. When producing fibers, the fibers can be used to produce nonwoven fabrics, ropes, nets, and the like. In one embodiment, the fibers can be used as a filler material in ballistic apparel.

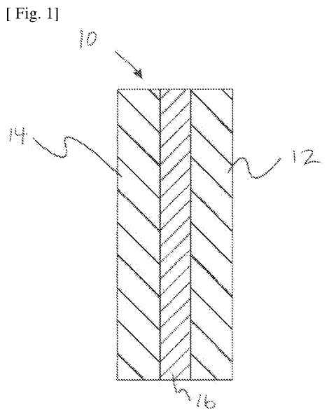

Referring to FIG. 1, one embodiment of a lithium ion battery 10 made in accordance with the present disclosure is shown. The battery 10 includes an anode 12 and a cathode 14. The anode 12, for instance, can be made from a lithium metal. The cathode 14, on the other hand, can be made from sulfur or from an intercalated lithium metal oxide. In accordance with the present disclosure, the battery 10 further includes a porous membrane 16 or separator that is positioned between the anode 12 and the cathode 14. The porous membrane 16 minimizes electrical shorts between the two electrodes while allowing the passage of ions, such as lithium ions. As shown in FIG. 1, in one embodiment, the porous membrane 16 is a single layer polymer membrane and does not include a multilayer or coextruded structure. In one aspect, the single layer polymer membrane may also include a coating. The coating can be an inorganic coating made from, for instance, aluminum oxide or a titanium oxide. Alternatively, the single layer polymer membrane may also include a polymeric coating or an inorganic coating. The inorganic coating, for instance, can be made from aluminum oxide or titanium oxide. The coating can provide increased thermal resistance.

Porous membranes made according to the present disclosure can generally have a thickness of greater than about 3 microns, such as greater than about 6 microns, such as greater than about 7 microns, such as greater than about 8 microns, such as greater than about 9 microns, such as greater than about 10 microns, such as greater than about 11 microns. The thickness of the membranes is generally less than about 20 microns, such as less than about 16 microns, such as less than about 14 microns, such as less than about 12 microns, such as less than about 10 microns, such as less than about 8 microns, such as less than 6 microns.

Membranes made according to the present disclosure can have excellent physical properties. For example, membranes having a porosity of from about 30% to about 50% can have a puncture strength of greater than about 1,060 mN/micron, such as greater than about 1, 100 mN/micron, such as greater than about 1, 200 mN/micron, and generally less than about 3,000 mN/micron.

Membranes made according to the present disclosure can also have excellent tensile strength properties in either the machine direction or the cross-machine direction. For instance, in either direction, the membrane can have a tensile strength of greater than about 115 MPa, such as greater than about 120 MPA, such as greater than about 125 MPa, and generally less than about 250 MPa.

Polymer membranes made according to the present disclosure can have a Gurley permeability of greater than about 105 sec/100 ml, such as greater than about 150 sec/100 ml, such as greater than about 200 sec/100 ml, such as greater than about 225 sec/100 ml, such as greater than about 250 sec/100 ml, such as greater than about 275 sec/100 ml, such as greater than about 300 sec/100 ml, such as greater than about 325 sec/100 ml, such as greater than about 350 sec/100 ml, such as greater than about 375 sec/100 ml, such as greater than about 400 sec/100 ml, such as greater than about 425 sec/100 ml, such as greater than about 450 sec/100 ml, such as greater than about 475 sec/100 ml, such as greater than about 500 sec/100 ml, such as greater than about 525 sec/100 ml, such as greater than about 550 sec/100 ml, such as greater than about 575 sec/100 ml, such as greater than about 600 sec/100 ml, and generally less than about 1,000 sec/100 ml, such as less than about 800 sec/100 ml, such as less than about 600 sec/100 ml, such as less than about 400 sec/100 ml.

Porous membranes made according to the present disclosure can generally have a porosity of greater than about 30%, such as greater than about 33%, such as greater than about 35%, and generally less than about 60%, such as less than about 55%, such as less than about 50%, such as less than about 45%. In one aspect, the porosity can be from about 35% to about 40%. In an alternative embodiment, the porosity can be from about 39% to about 45%. The mean pore size can generally be greater than about 20 nm, such as greater than about 23 nm, such as greater than about 25 nm, such as greater than about 26 nm, and generally less than about 50 nm, such as less than about 45 nm, such as less than about 40 nm, such as less than about 35 nm.

In addition to the above properties and characteristics, polymer articles, particularly porous membranes, made in accordance with the present disclosure also have dramatically enhanced wettability properties. For example, the grafted polyethylene polymer of the present disclosure can be incorporated into a polymer article sufficient to reduce a contact angle of the article when measured against water in an amount greater than about 4%, such as in an amount greater than about 5%, such as in an amount greater than about 6%, such as in an amount greater than about 7%. Polymer articles, such as porous membranes, made in accordance with the present disclosure, for instance, may display a contact angle against water of less than about 105°, such as less than about 102°, such as less than about 100°, such as less than about 98°, and generally greater than about 50°.

The grafted polyethylene polymer can also dramatically enhance the ability of molded articles, such as porous membranes, to wick fluids, particularly electrolyte fluids. For example, when subjected to a soaking test in propylene carbonate, the presence of the grafted polyethylene polymer can increase the wicking distance by greater than about 10%, such as by greater than about 20%, such as by greater than about 30%, such as by greater than about 35% in comparison to a similar membrane not containing the grafted polyethylene polymer. The soaking distance of membranes can vary depending on many factors such as the porosity of the membrane and the pore size.

The polymer composition and polymer articles made in accordance with the present disclosure may contain various other additives, such as heat stabilizers, light stabilizers, UV absorbers, acid scavengers, flame retardants, lubricants, colorants, and the like.

In one embodiment, a heat stabilizer may be present in the composition. The heat stabilizer may include, but is not limited to, phosphites, aminic antioxidants, phenolic antioxidants, or any combination thereof.

In one embodiment, an antioxidant may be present in the composition. The antioxidant may include, but is not limited to, secondary aromatic amines, benzofuranones, sterically hindered phenols, or any combination thereof.

In one embodiment, a light stabilizer may be present in the composition. The light stabilizer may include, but is not limited to, 2-(2′-hydroxyphenyl)-benzotriazoles, 2-hydroxy-4-alkoxybenzophenones, nickel containing light stabilizers, 3, 5-di-tert-butyl-4-hydroxbenzoates, sterically hindered amines (HALS), or any combination thereof.

In one embodiment, a UV absorber may be present in the composition in lieu of or in addition to the light stabilizer. The UV absorber may include, but is not limited to, a benzotriazole, a benzoate, or a combination thereof, or any combination thereof.

In one embodiment, a halogenated flame retardant may be present in the composition. The halogenated flame retardant may include, but is not limited to, tetrabromobisphenol A (TBBA), tetrabromophthalic acid anhydride, dedecachloropentacyclooctadecadiene (dechlorane), hexabromocyclodedecane, chlorinated paraffins, or any combination thereof.

In one embodiment, a non-halogenated flame retardant may be present in the composition. The non-halogenated flame retardant may include, but is not limited to, resorcinol diphosphoric acid tetraphenyl ester (RDP), ammonium polyphosphate (APP), phosphine acid derivatives, triaryl phosphates, trichloropropylphosphate (TCPP), magnesium hydroxide, aluminum trihydroxide, antimony trioxide.

In one embodiment, a lubricant may be present in the composition. The lubricant may include, but is not limited to, silicone oil, waxes, molybdenum disulfide, or any combination thereof.

In one embodiment, a colorant may be present in the composition. The colorant may include, but is not limited to, inorganic and organic based color pigments.

In one aspect, an acid scavenger may be present in the polymer composition. The acid scavenger, for instance, may comprise an alkali metal salt or an alkaline earth metal salt. The salt can comprise a salt of a fatty acid, such as a stearate. Other acid scavengers include carbonates, oxides, or hydroxides. Particular acid scavengers that may be incorporated into the polymer composition include a metal stearate, such as calcium stearate. Still other acid scavengers include zinc oxide, calcium carbonate, magnesium oxide, and mixtures thereof.

These additives may be used singly or in any combination thereof. In general, each additive may be present in an amount of at least about 0.05 wt. %, such as at last about 0.1 wt. %, such as at least about 0.25 wt. %, such as at least about 0.5 wt. %, such as at least about 1 wt. % and generally less than about 20 wt. %, such as less than about 10 wt. %, such as less than about 5 wt. %, such as less than about 4 wt. %, such as less than about 2 wt. %. The sum of the wt. % of all of the components, including any additives if present, utilized in the polymer composition will be 100 wt. %.

The present disclosure may be better understood with reference to the following example. The following example is given below by way of illustration and not by way of limitation. The following experiments were conducted in order to show some of the benefits and advantages of the present invention.

### Example No. 1

Various resin compositions were formulated containing a base resin of a high density polyethylene. In particular, the high density polyethylene polymer was combined with a polyethylene polymer that had been grafted with a surface tension reducing agent or completely replaced with a grafted polyethylene polymer. The high density polyethylene polymer formulations were combined with a plasticizer and formed into porous membranes using a gel extrusion process as described above. More particularly, the compositions were prepared into membranes via gel extrusion, biaxial stretching, and solvent extraction as are conventional. The blends were gel extruded using a solid content of 30 wt. % resin and paraffin oil at a temperature of about 190 °C to about 240 °C and a screw speed of 200 rpm. After extrusion, the resulting membrane was solidified on a chill roller set to 40 °C. Stretching was performed in an approximate 7×7 ratio (MD/TD) at a temperature of 120 °C. Extraction of the stretched membranes was performed in acetone. The membranes were annealed at 130 °C for 10 minutes.

The four membranes were then tested for Gurley permeability and subjected to the soaking test with propylene carbonate. The table below provides the polymer formulations and the results obtained. In Sample Nos. 1-3, the high density polyethylene polymer had a molecular weight of 700,000 g/mol and had an average particle size of 127 microns. Sample No. 4 was formed with a high density polyethylene polymer having a molecular weight of 1.7 million g/mol and had an average particle size of 115 microns. Samples Nos. 5 and 6 were formed from a non-grafted high density polyethylene polymer having a molecular weight of 1.7 million g/mol blended with a grafted high density polyethylene polymer having a molecular weight of 700,000 g/mol. Sample Nos. 7-12 were all formed with a high density polyethylene polymer having a molecular weight of 700,000 g/mol and having an average particle size of 115 microns.

The surface tension reducing agents tested included maleic anhydride, acrylic acid and vinyltrimethoxysilane. Sample Nos. 2 and 3, for instance, included a grafted high density polyethylene polymer containing 4.6% by weight maleic anhydride. Sample Nos. 5 and 6 contained a grafted high density polyethylene polymer containing greater than 4.6% by weight acrylic acid. Sample Nos. 8 and 9 contained a grafted high density polyethylene polymer containing 4.6% by weight acrylic acid. Sample Nos. 11 and 12 included a high density polyethylene polymer containing 5% by weight vinyltrimethoxysilane.

| Sample | | Loading | Gurley | Thickness | Soaking |
|---|---|---|---|---|---|
| No. | Formulation | [%] | [sec/100 cc] | [μm] | improvement |
| 1 | Non-grafted polyethylene polymer | 100 | 235 | 7.8 | Reference |
| 2 | Non-grafted polyethylene polymer | 50 | 237.5 | 7.7 | +28% |
| | Polyethylene polymer grafted with | 50 | | | |
| | maleic anhydride | | | | |
| 3 | Polyethylene polymer grafted with | 100 | 248.7 | 7.1 | +44% |
| | maleic anhydride | | | | |
| 4. | Non-grafted polyethylene polymer | 100 | 232.2 | 10 | Reference |
| 5 | Non-grafted polyethylene polymer | 75 | 216.1 | 10.4 | +43% |
| | Polyethylene polymer grafted with | 25 | | | |
| | acrylic acid | | | | |
| 6 | Non-grafted polyethylene polymer | 50 | 209 | 10 | +51% |
| | Polyethylene polymer grafted with | 50 | | | |
| | acrylic acid | | | | |
| 7 | Non-grafted polyethylene polymer | 100 | 210.5 | 7.9 | Reference |
| 8 | Non-grafted polyethylene polymer | 40 | 161.6 | 8.6 | +38% |
| | Polyethylene polymer grafted with | 60 | | | |
| | acrylic acid | | | | |
| 9 | Non-grafted polyethylene polymer | 20 | 210.1 | 8.9 | +46% |
| | Polyethylene polymer grafted with | 80 | | | |
| | acrylic acid | | | | |
| 10 | Non-grafted polyethylene polymer | 100 | 267 | 7.2 | Reference |
| 11 | Non-grafted polyethylene polymer | 50 | 192 | 8.9 | +21 |
| | Polyethylene polymer grafted with | 50 | | | |
| | vinyltrimethoxysilane | | | | |
| 12 | Polyethylene polymer grafted with | 100 | 188 | 10.3 | +34 |
| | vinyltrimethoxysilane | | | | |

As shown above, incorporating a grafted polyethylene polymer into the polymer composition in accordance with the present disclosure dramatically improved the wicking properties of membranes formed from the polymer.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A porous membrane comprising:
a high density polyethylene polymer grafted with a surface tension reducing agent, the surface tension reducing agent comprising acrylic acid groups, a maleic anhydride, or a silane; and
optionally a high density polyethylene polymer not grafted with a surface tension reducing agent, the high density polyethylene polymer being blended with the high density polyethylene polymer grafted with the surface tension reducing agent.

2. (canceled)

3. A porous membrane as defined in claim 1, wherein the surface tension reducing agent is present in the porous membrane in an amount sufficient to reduce a contact angle of the membrane when measured against water of greater than about 4%, in comparison to an identical porous membrane not containing the high density polyethylene polymer grafted with the surface tension reducing agent.

4. A porous membrane as defined in claim 1, wherein the porous membrane displays a contact angle when measured against water of less than about 105°.

5. A porous membrane as defined in claim 1, wherein the surface tension reducing agent is present in the porous membrane in an amount greater than about 0.001% by weight and less than about 20% by weight.

6. A porous membrane as defined in claim 1, wherein the surface tension reducing agent is present in the porous membrane in an amount sufficient to increase a wicking distance when subjected to a soaking test and tested against propylene carbonate of greater than 10%, in comparison to an identical porous membrane not containing the high density polyethylene polymer grafted to the surface tension reducing agent.

7. A porous membrane as defined in claim 1, wherein the surface tension reducing agent comprises the acrylic acid groups.

8. A porous membrane as defined in claim 1, wherein the surface tension reducing agent comprises the maleic anhydride.

9. A porous membrane as defined in claim 1, wherein the surface tension reducing agent comprises the silane, such as vinyltrimethoxysilane.

10. A porous membrane as defined in claim 1, wherein the high density polyethylene polymer grafted with the surface tension reducing agent is blended with the high density polyethylene polymer not grafted with the surface tension reducing agent.

11. A porous membrane as defined in claim 10, wherein the high density polyethylene polymer and the high density polyethylene polymer grafted with the surface tension reducing agent have the same average molecular weight.

12. A porous membrane as defined in claim 10, wherein the high density polyethylene polymer and the high density polyethylene polymer grafted with the surface tension reducing agent have different average molecular weights.

13. A porous membrane as defined in claim 10, wherein the high density polyethylene polymer and the high density polyethylene polymer grafted with the surface tension reducing agent each have an average molecular weight of greater than about 300,000 g/mol, and less than about 12,000,000 g/mol.

14. (canceled)

15. A porous membrane as defined in claim 7, wherein the acrylic acid grafted to the high density polyethylene polymer has been saponified with a base.

16. A porous membrane as defined in claim 15, wherein the base comprises a metal hydroxide.

17. (canceled)

18. A porous membrane as defined in claim 1, wherein the membrane has a thickness of from about 5 microns to about 20 microns.

19. A porous membrane as defined in claim 1, wherein the membrane has a Gurley permeability of greater than about 105 sec/100 mL.

20. A porous membrane as defined in claim 1, wherein the membrane has a porosity of from about 32% to about 50%.

21. A polymer composition for producing gel extruded articles comprising:
a plasticizer;
high density polyethylene particles grafted with a surface tension reducing agent, the surface tension reducing agent comprising acrylic acid groups, a maleic anhydride, or a silane; and
optionally high density polyethylene polymer particles not grafted with a surface tension reducing agent, the high density polyethylene polymer particles being blended with the high density polyethylene polymer particles grafted with the surface tension reducing agent.

22. A polymer composition as defined in claim 21, wherein the surface tension reducing agent comprises the acrylic acid groups, the acrylic acid groups comprising an acrylic acid, an acrylic acid salt, or an acrylic acid group attached to a spacer group.

23-27. (canceled)

28. A process for producing polymer articles comprising:
forming the polymer composition as defined in claim 21 into a gel-like composition;
extruding the gel-like composition through a die to form a polymer article, the polymer article comprising a film.

29-31. (canceled)
